(19) United States
(12) Patent Application Publication
(10) Pub. No.: US 2026/0205717 A1
(43) Pub. Date: Jul. 16, 2026

(54) IMAGE SENSOR FOR CAPTURING WHITE LIGHT AND INFRARED LIGHT AND METHOD OF ACQUIRING PIXEL VALUES FOR PIXEL GROUP OF THE IMAGE SENSOR

(71) Applicant: Himax Imaging Limited, Tainan City (TW)

(72) Inventor: Yang WU, Tainan City (TW)

(21) Appl. No.: 19/015,680

(22) Filed: Jan. 10, 2025

(51) Int. Cl. H04N 25/77; H04N 23/11; H04N 25/441; H04N 25/51; H04N 25/59

(52) U.S. Cl. CPC H04N 25/77; H04N 23/11; H04N 25/441; H04N 25/51; H04N 25/59

(57) ABSTRACT

An image sensor is provided. The image sensor includes pixel groups, and each pixel group includes white pixels, infrared pixels and a shared circuit. The pixels share a floating diffusion node for selectively transferring an electric charge stored therein. The shared circuit connects the floating diffusion node for converting the electric charge of each white and infrared pixel to a corresponding pixel value based on the first or second conversion gain. In a first mode, one white pixel is read as a first pixel value in a first period and one infrared pixel is read as a third pixel value in a third period based on the first conversion gain; the other one white pixel is read as a second pixel value in a second period and the other one infrared pixel is read as a fourth pixel value in a fourth period based on the second conversion gain.

### BACKGROUND

### Technical field

The disclosure relates to an image sensor for capturing white light and infrared light and method of acquiring pixel values for pixel group of the image sensor.

### Description of Related Art

Conventional W/IR sensors, while capable of supporting basic operation modes, suffer from limited dynamic range (DR). This limitation is due to their single gain readout design, which struggles to capture both bright and dark details simultaneously, resulting in overexposed highlights or loss of shadow detail. In addition, conventional HDR technologies often require additional hardware designs, such as multi-exposure or multi-channel readout, which increase the complexity and cost of sensor manufacturing.

### SUMMARY

An objective of the present disclosure is to provide an image sensor for capturing white light and infrared light. The image sensor includes several pixel groups, and each of the pixel groups includes two white pixels, two infrared pixels, and a shared circuit. The two white pixels and two infrared pixels share a floating diffusion node for selectively transferring a stored electric charge to the floating diffusion node. The shared circuit is electrically connected to the floating diffusion node for selectively setting the floating diffusion node to a first conversion gain or a second conversion gain and converting the stored electric charge of each of the two white pixels and the two infrared pixels to a corresponding pixel value based on the first conversion gain or the second conversion gain. In response to the image sensor being operated in a first mode, one of the two white pixels is read as a first pixel value in a first period based on the first conversion gain, the other one of the two white pixels is read as a second pixel value in a second period based on the second conversion gain, one of the two infrared pixels is read as a third pixel value in a third period based on the first conversion gain, and the other one of the two infrared pixels is read as a fourth pixel value in a fourth period based on the second conversion gain.

Another objective of the present disclosure is to provide a method of acquiring pixel values for a pixel group of an image sensor. The image sensor is used to capture white light and infrared light, and each of the pixel groups includes two white pixels, two infrared pixels and a shared circuit. The two white pixels and the two infrared pixels share a floating diffusion node which is electrically connected to the shared circuit. The method comprises the following steps in response to the image sensor being operated in a first mode: setting the floating diffusion node to a first conversion gain for converting a first electric charge stored in one of the two white pixels to a first pixel value in a first period based on the first conversion gain; setting the floating diffusion node to a second conversion gain for converting a second electric charge stored in the other one of the two white pixels to a second pixel value in a second period based on the second conversion gain; setting the floating diffusion node to the first conversion gain for converting a third electric charge stored in one of the two infrared pixels to a third pixel value in a third period based on the first conversion gain; and setting the floating diffusion node to the second conversion gain for converting a fourth electric charge stored in the other one of the two infrared pixels to a fourth pixel value in a fourth period based on the second conversion gain.

### BRIEF DESCRIPTION OF THE DRAWINGS

FIG. 1 is a schematic diagram showing an image sensor with color filters for capturing white light and infrared light in accordance with an embodiment of the present disclosure.

FIG. 2 is a schematic diagram showing one of the pixel groups in accordance with an embodiment of the present disclosure.

FIG. 3 is a schematic diagram showing a detailed structural diagram of the pixel group according to an embodiment of the present disclosure.

FIG. 4 is a schematic diagram showing multiple pixel groups interconnected to collectively output mixed pixel values in accordance with an embodiment of the present disclosure.

FIG. 5 is a flowchart of a method of acquiring pixel values for a pixel group of an image sensor in a first mode in accordance with an embodiment of the present disclosure.

FIGS. 6 to 9 are schematic diagrams showing the operational of the pixel group corresponding to each step in the first mode in accordance with an embodiment of the present disclosure.

FIG. 10 is a flowchart of a method of acquiring pixel values for pixel groups of an image sensor in a second mode in accordance with an embodiment of the present disclosure.

FIGS. 11 to 14 are schematic diagrams showing the operational of the pixel group corresponding to each step in the second mode in accordance with an embodiment of the present disclosure.

FIG. 15 is a flowchart of a method of acquiring pixel values for a pixel group of an image sensor in a third mode in accordance with an embodiment of the present disclosure.

FIGS. 16 to 19 are schematic diagrams showing the operational of the pixel group corresponding to each step in the third mode in accordance with an embodiment of the present disclosure.

### DETAILED DESCRIPTION

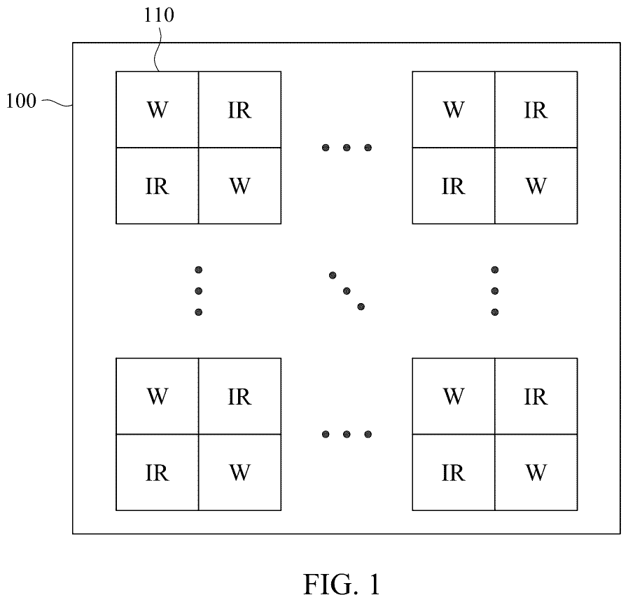

Referring to FIG. 1, FIG. 1 is a schematic diagram showing an image sensor 100 with color filters for capturing white light and infrared light in accordance with an embodiment of the present disclosure. The image sensor 100 is composed of multiple pixel groups 110, and each of the pixel groups 110 are arranged in a 2×2 matrix including two white pixels W and two infrared pixels IR. The white pixels W capture visible light signals and the infrared pixels IR detect infrared signals to enhance image quality in low light or no light environments. Within each pixel group 110, the white pixels W are arranged in the top-left and bottom-right corners, and the infrared pixels IR are arranged in the top-right and bottom-left corners. In other words, pixels of the same color filters within each pixel group 110 are arranged diagonally.

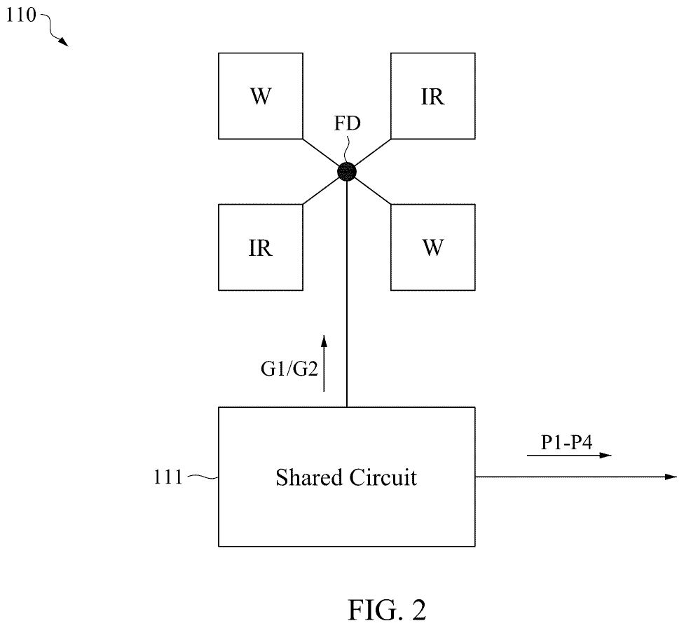

Referring to FIG. 2, FIG. 2 is a schematic diagram showing one of the pixel groups 110 in accordance with an embodiment of the present disclosure. Each pixel group 110, in addition to containing the white pixels W and the infrared pixels IR, also includes a shared circuit 111, which is used to convert electric charges stored in the white pixels W and the infrared pixels IR into the corresponding pixel values P1-P4.

In each pixel group 110, the two white pixels W and the two infrared pixels IR share a floating diffusion node FD for selectively transferring the stored electric charges to the floating diffusion node FD. The shared circuit 111 is electrically connected to the floating diffusion node FD for selectively setting the floating diffusion node FD to a first conversion gain G1 or a second conversion gain G2. Based on the selected conversion gain G1 or G2, the shared circuit 111 converts the stored electric charges from the white pixels W and the infrared pixels IR into their respective pixel values P1-P4.

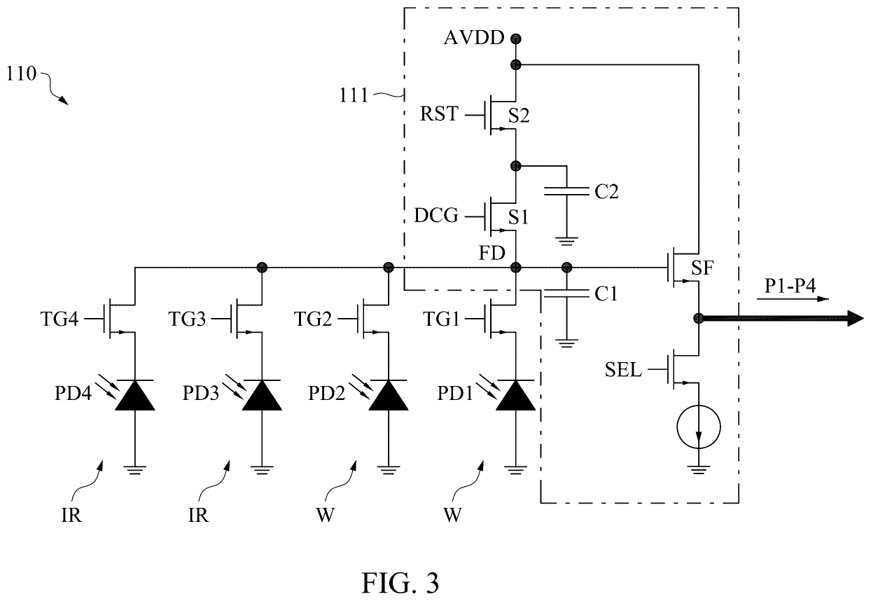

FIG. 3 is a schematic diagram showing a detailed structural diagram of the pixel group 110 according to an example of the present disclosure. The pixel group 110 includes photoelectric conversion elements PD1-PD4 and transfer switches TG1-TG4 corresponding to the two white pixels W and the two infrared pixels IR, respectively. That is, each pixel corresponds to one photoelectric conversion element and one transfer switch. The photoelectric conversion elements PD1-PD4 are used to convert received photons into the stored electric charges, which are then transferred to the floating diffusion node FD when the transfer switches TG1-TG4 are turned on.

In the embodiments of the present disclosure, depending on the operating modes, the transfer switches TG1-TG4 can be controlled to operate in a time-division and sequential manner or to simultaneously activate two transfer switches first, followed by the activation of the other two. Through these operating modes, the electric charges stored in the two white pixels W and the two infrared pixels IR can be transferred to the floating node FD in a specific sequence and subsequently converted into their corresponding pixel values P1-P4 for readout.

The shared circuit 111 includes an output switch SEL. The on/off states of the output switch SEL can be used to control the timing and sequence in which the first pixel value P1, the second pixel value P2, the third pixel value P3, and the fourth pixel value P4 are read out. In some embodiments, the output switch SEL is turned on correspondingly in response to the on-time period of the transfer switches TG1-TG4. The shared circuit 111 further includes a gain buffer SF (such as a source follower gain buffer), which is a part of the analog gain stages and can be turned on or off by the gate signal of the output switch SEL. A node to which the gain buffer SF and the output switch SEL are connected is used to output the first pixel value P1, the second pixel value P2, the third pixel value P3, and the fourth pixel value P4.

The shared circuit 111 includes a first capacitor C1, a second capacitor C2, and a first switch S1. A first terminal of the first switch S1 is electrically connected to the floating diffusion node FD and the first capacitor C1, a second terminal of the first switch S1 is electrically connected to the second capacitor C2, and a control terminal receives a control signal DCG.

When the first switch S1 is turned off according to the control signal DCG, the second capacitor C2 is not electrically connected to the floating diffusion node FD. The floating diffusion node FD is electrically connected only to the first capacitor C1, thereby configuring the floating diffusion node to have the first conversion gain G1. In this example of the shared circuit 111, the first conversion gain G1 can be equivalently expressed as 1/C1.

When the first switch is turned on according to the control signal DCG, the second capacitor C2 is electrically connected to the floating diffusion node FD. The floating diffusion node FD is electrically connected to both the first capacitor C1 and the second capacitor C2, thereby configuring the floating diffusion node FD to have the second conversion gain G2. In this example of the shared circuit 111, the second conversion gain G2 can be equivalently expressed as 1/(C1+C2). In such embodiment, the second conversion gain G2 is smaller than the first conversion gain G1.

The shared circuit 111 further includes a second switch S2. The second switch S2 is electrically connected between a supply voltage AVDD and the first switch S1 and is used to reset the floating diffusion node FD, thereby clearing residual electric charges in the floating diffusion node FD.

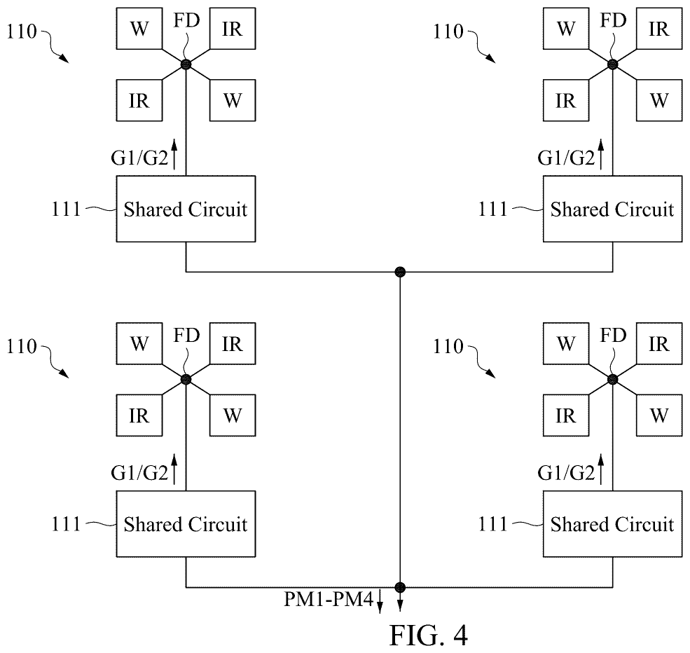

Referring to FIG. 4, FIG. 4 is a schematic diagram showing multiple pixel groups 110 interconnected to collectively output mixed pixel values PM1-PM4 in accordance with an embodiment of the present disclosure. In this embodiment, the output terminals of the shared circuits 111 of multiple pixel groups 110 are interconnected to fuse the pixel values (P1/P2/P3/P4) generated by each pixel group 110 at the same time period, thereby producing the mixed pixel values (PM1/PM2/PM3/PM4).

Although not shown in FIG. 4, the shared circuits 111 are connected to each other by their respective output of the gain buffers SF to fuse multiple pixel values (P1/P2/P3/P4) into the mixed pixel values (PM1/PM2/PM3/PM4) on the same path when the gain buffers SF are turned on simultaneously. The number of the gain buffers SF turned on during the same time period can be used to determine the number of pixel values to be fused to achieve the desired pixel binning effect and signal-to-noise ratio (SNR) improvement.

For example, during the first period, four pixel groups 110 generate their respective first pixel values P1, which are mixed through the interconnected output terminals of the shared circuit 111 to produce the final first mixed pixel value PM1. During the second period, four pixel groups 110 generate their respective second pixel values P2, which are mixed through the interconnected output terminals of the shared circuit 111 to produce the final second mixed pixel value PM2. The third mixed pixel value PM3 and the fourth mixed pixel value PM4 are produced in the same manner during the third period and the fourth period, respectively. Through this binning structure, the pixel values from multiple pixels are combined into a single output, effectively enhancing the signal-to-noise ratio (SNR) and readout speed while reducing the readout capacity. In other embodiments, the output terminals of the shared circuits 111 of more pixels groups 110 may be connected together to allow for lower resolution, higher SNR, and smaller readout capacity.

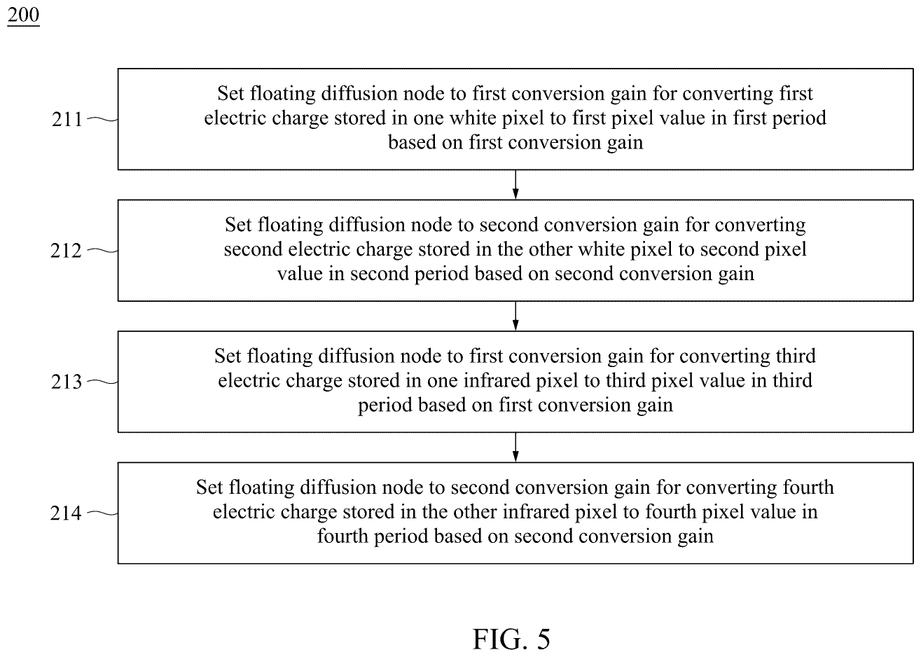

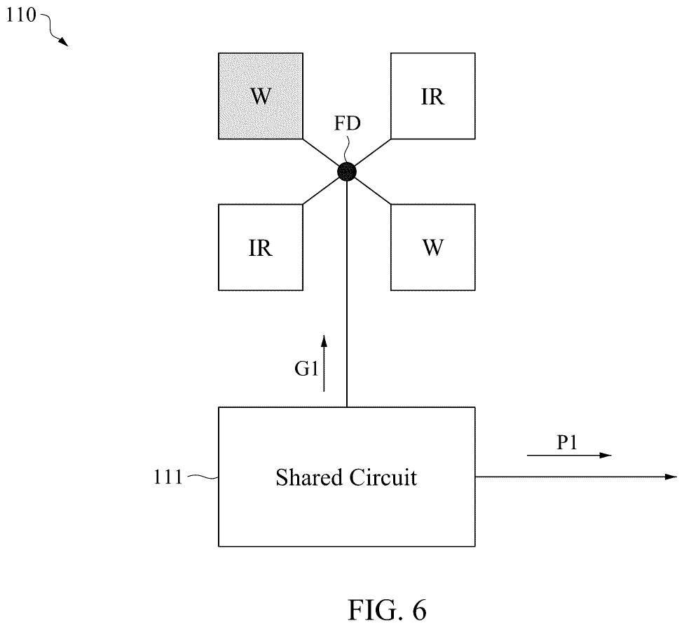

Referring to FIG. 5, FIG. 5 is a flowchart of a method 200 of acquiring pixel values for a pixel group of an image sensor in a first mode in accordance with an embodiment of the present disclosure. The method 200 of the present disclosure is applicable to W/IR sensors that capture both white light and infrared light. In the following, the pixel group 110 shown in FIG. 2 is used as examples to explain how the pixel group 110 operates in the first mode. As shown in FIG. 5, the method 200 includes Steps 211 to 214, and each step corresponding to the operational schematic diagrams of the pixel group 110 shown in FIGS. 6 to 9.

At Step 211, corresponding to FIG. 6, the floating diffusion node FD is set to the first conversion gain G1, and based on the first conversion gain G1, the electric charge stored in the top-left white pixel W is converted into the first pixel value P1 during a first period.

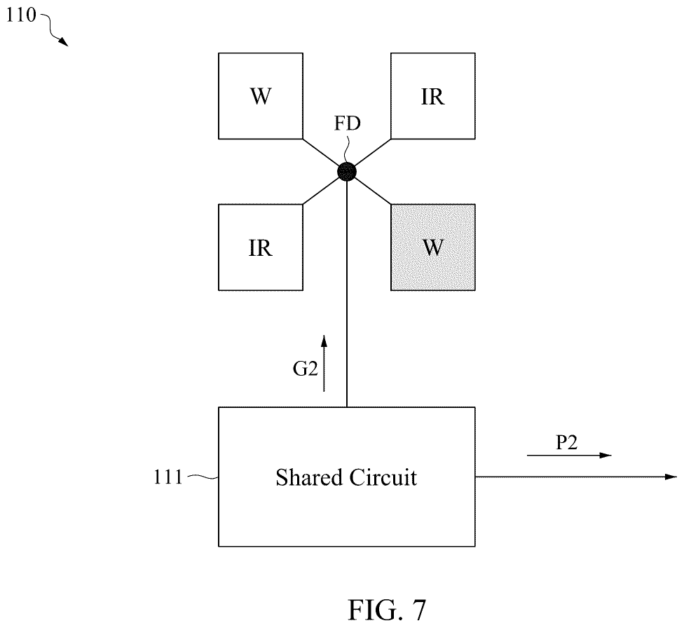

At Step 212, corresponding to FIG. 7, the floating diffusion node FD is set to the second conversion gain G2, and based on the second conversion gain G2, the electric charge stored in the bottom-right white pixel W is converted into the second pixel value P2 during a second period.

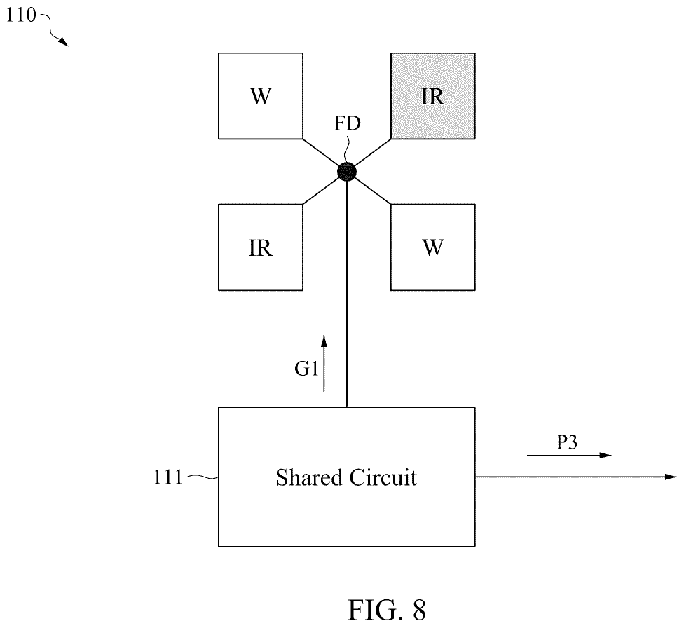

At Step 213, corresponding to FIG. 8, the floating diffusion node FD is set to the first conversion gain G1, and based on the first conversion gain G1, the electric charge stored in the top-right infrared pixel IR is converted into the third pixel value P3 during a third period.

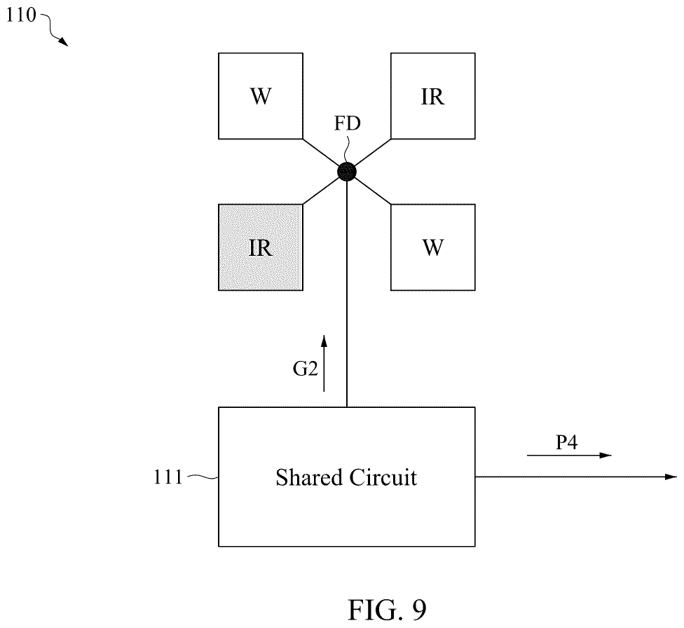

At Step 214, corresponding to FIG. 9, the floating diffusion node FD is set to the second conversion gain G2, and based on the second conversion gain G2, the electric charge stored in the bottom-left infrared pixel IR is converted into the fourth pixel value P4 during a fourth period.

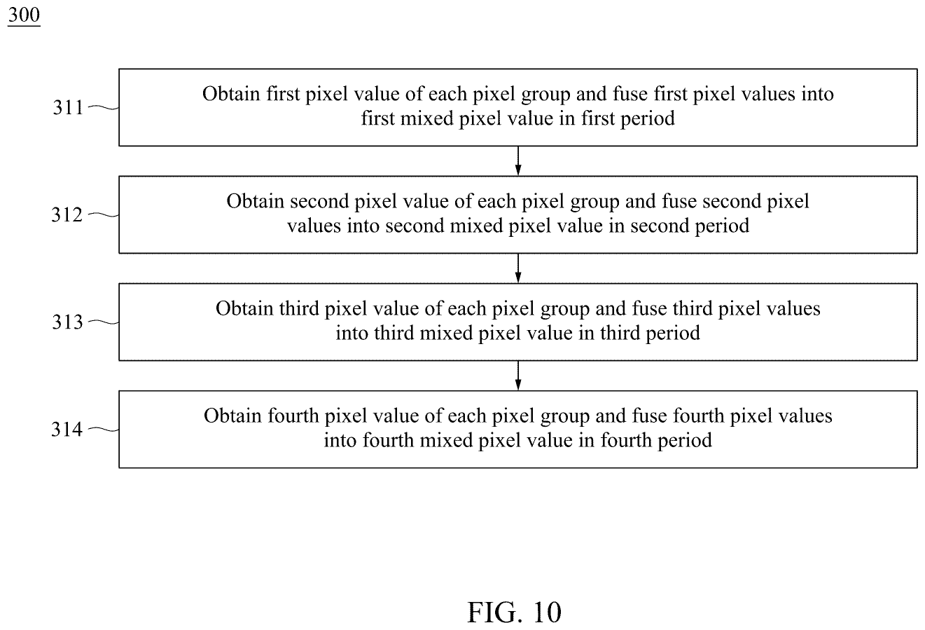

Referring to FIG. 10, FIG. 10 is a flowchart of a method 300 of acquiring pixel values for pixel groups of an image sensor in a second mode in accordance with an embodiment of the present disclosure. The method 300 of the present disclosure is applicable to W/IR sensors that capture both white light and infrared light. In the following, the pixel groups 110 shown in FIG. 4 are used as example to explain how the pixel groups 110 operate in the second mode.

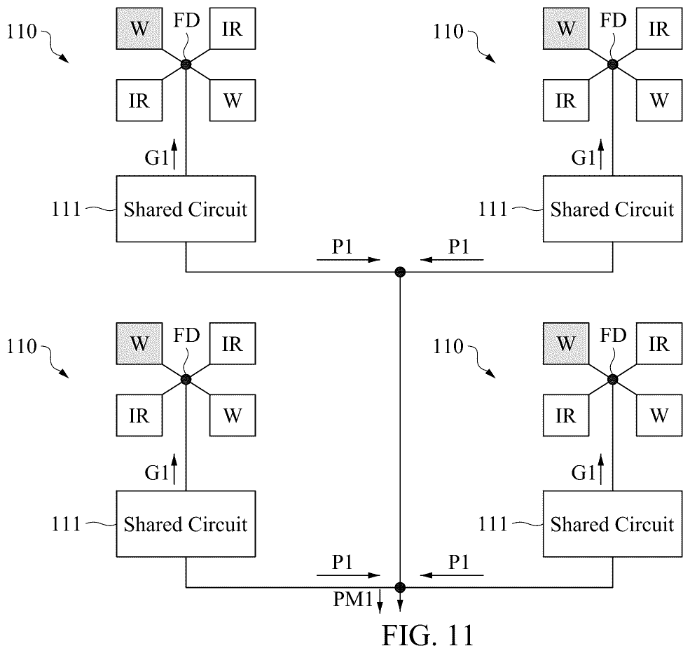

As shown in FIG. 10, the method 300 includes Steps 311 to 314, and each step corresponding to the operational schematic diagrams of the pixel groups 110 shown in FIGS. 11 to 14. In the second mode, the operation of each pixel group 110 is similar to the operation of the pixel group 110 in the first mode. The difference between the second mode and the first mode is that the interconnected shared circuits 111 of the pixel groups 110 are used to fuse the pixel values (P1/P2/P3/P4) generated by each pixel group 110 to produce the mixed pixel values (PM1/PM2/PM3/PM4) during the first period to the fourth period.

At Step 311, corresponding to FIG. 11, the first pixel values P1 generated by the top-left white pixel W of each pixel group 110 are fused to produce the first mixed pixel value PM1 with the first conversion gain G1 during the first period. The method by which each pixel group 110 generates the first pixel value P1 is similar to Step 211 of the first mode and will not be repeated here.

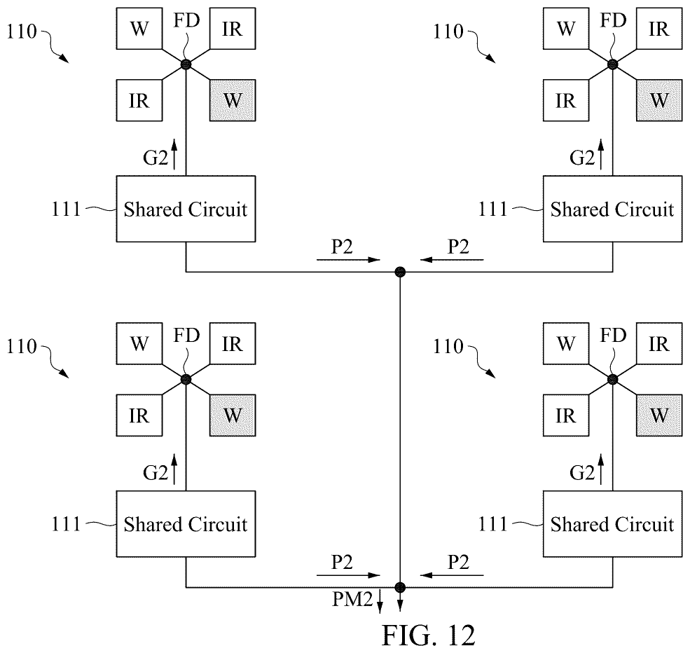

At Step 312, corresponding to FIG. 12, the second pixel values P2 generated by the bottom-right white pixel W of each pixel group 110 are fused to produce the second mixed pixel value PM2 with the second conversion gain G2 during the second period. The method by which each pixel group 110 generates the second pixel value P2 is similar to Step 212 of the first mode and will not be repeated here.

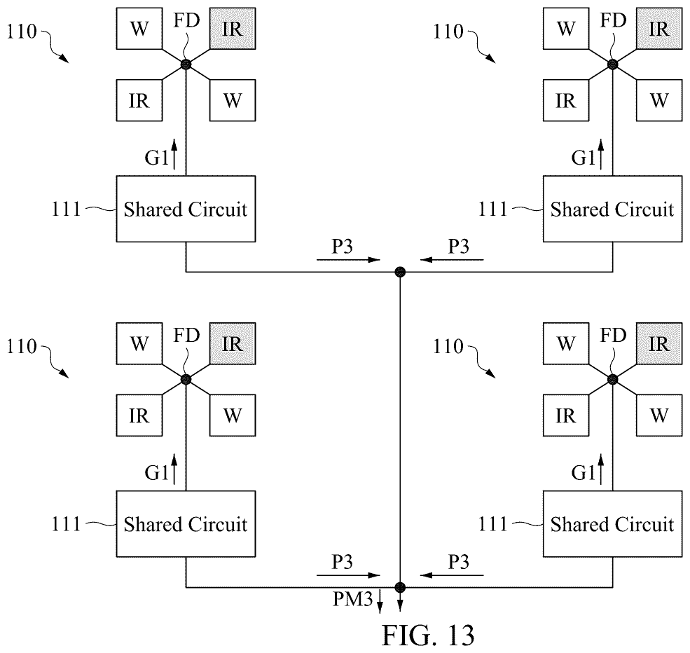

At Step 313, corresponding to FIG. 13, the third pixel values P3 generated by the top-right infrared pixel IR of each pixel group 110 are fused to produce the third mixed pixel value PM3 with the first conversion gain G1 during the third period. The method by which each pixel group 110 generates the third pixel value P3 is similar to Step 213 of the first mode and will not be repeated here.

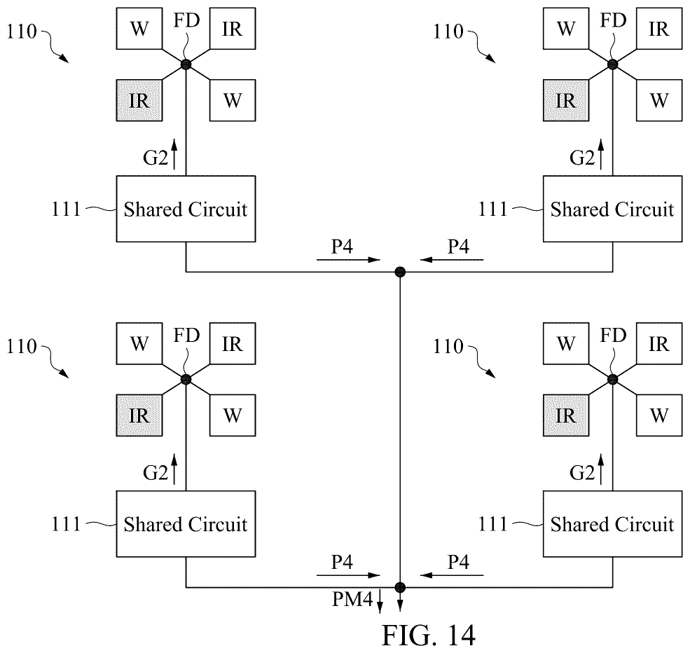

At Step 314, corresponding to FIG. 14, the fourth pixel values P4 generated by the bottom-left infrared pixel IR of each pixel group 110 are fused to produce the fourth mixed pixel value PM4 with the second conversion gain G2 during the fourth period. The method by which each pixel group 110 generates the fourth pixel value P4 is similar to Step 214 of the first mode and will not be repeated here.

Thus, the signals from multiple pixels are combined into a single output at a given timing, effectively increasing the accumulation of photoelectric signals to enhance the SNR while reducing the readout capacity.

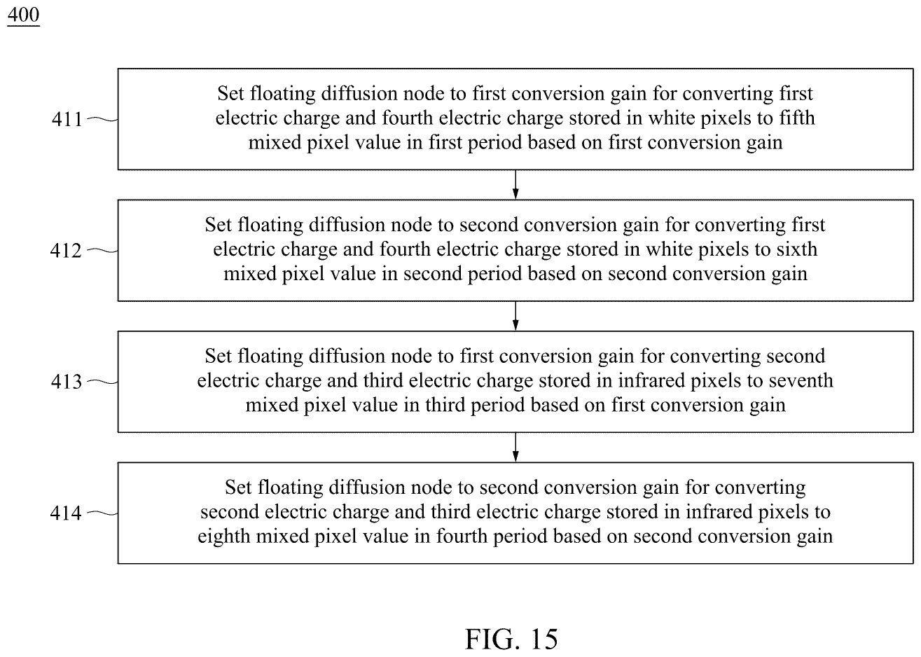

Referring to FIG. 15, FIG. 15 is a flowchart of a method 400 of acquiring pixel values for a pixel group of an image sensor in a third mode in accordance with an embodiment of the present disclosure. The method 400 of the present disclosure is applicable to W/IR sensors that capture both white light and infrared light. In the following, the pixel group 110 shown in FIG. 2 is used as example to explain how the pixel group 110 operates in the third mode.

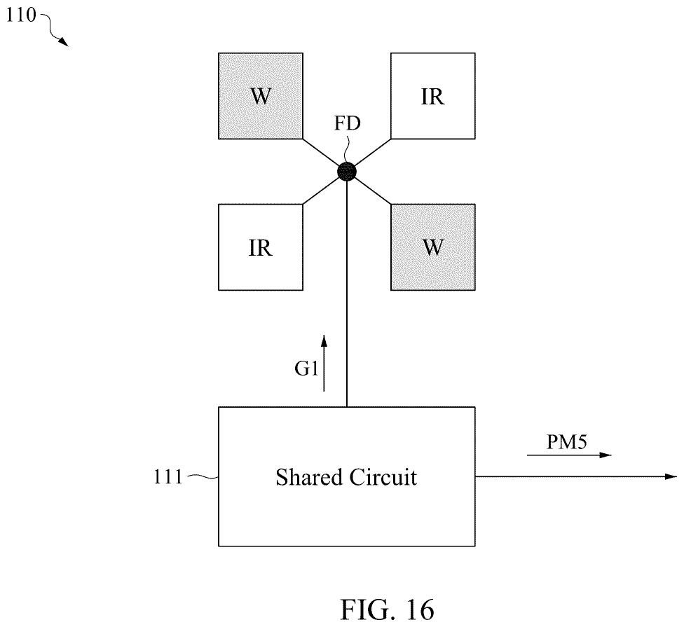

As shown in FIG. 15, the method 400 includes Steps 411 to 414, and each step corresponding to the operational schematic diagrams of the pixel group 110 shown in FIGS. 16 to 19.

At Step 411, corresponding to FIG. 16, the floating diffusion node FD is set to the first conversion gain G1, and based on the first conversion gain G1, the electric charges stored in the two white pixels W are converted into the fifth mixed pixel value PM5 during the first period. That is, the electric charges stored in the two white pixels W are simultaneously transferred to the floating diffusion node FD and are collectively converted into the fifth mixed pixel value PM5 based on the first conversion gain G1.

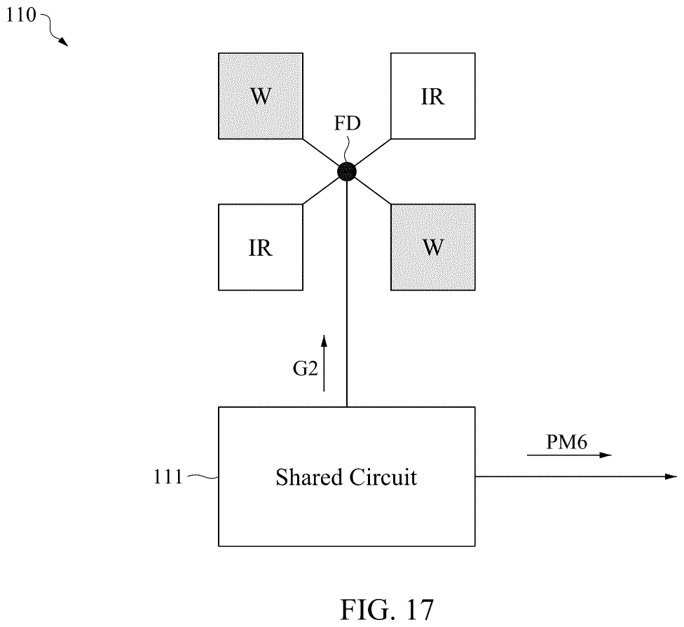

At Step 412, corresponding to FIG. 17, the floating diffusion node FD is set to the second conversion gain G2, and based on the second conversion gain G2, the electric charges stored in the two white pixels W are converted into the sixth mixed pixel value PM6 during the second period. That is, the electric charges stored in the two white pixels W are simultaneously transferred to the floating diffusion node FD and are collectively converted into the sixth mixed pixel value PM6 based on the second conversion gain G2.

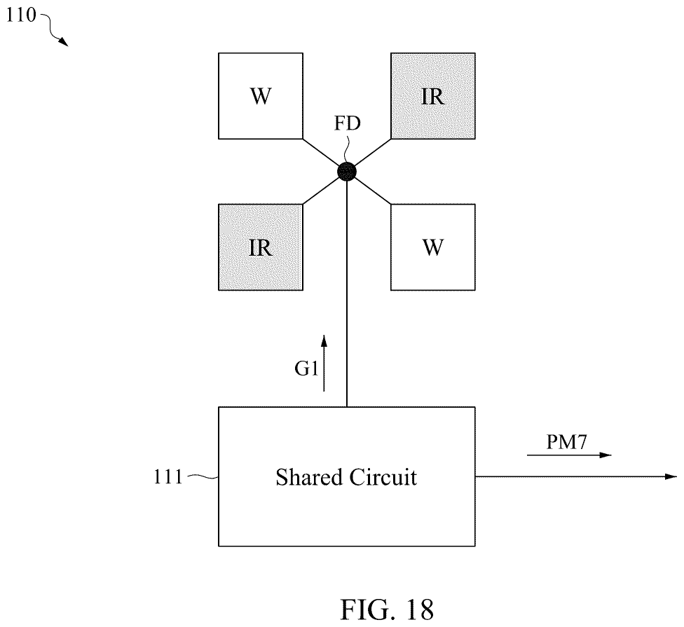

At Step 413, corresponding to FIG. 18, the floating diffusion node FD is set to the first conversion gain G1, and based on the first conversion gain G1, the electric charges stored in the two infrared pixels IR are converted into the seventh mixed pixel value PM7 during the third period. That is, the electric charges stored in the two infrared pixels IR are simultaneously transferred to the floating diffusion node FD and are collectively converted into the seventh mixed pixel value PM7 based on the first conversion gain G1.

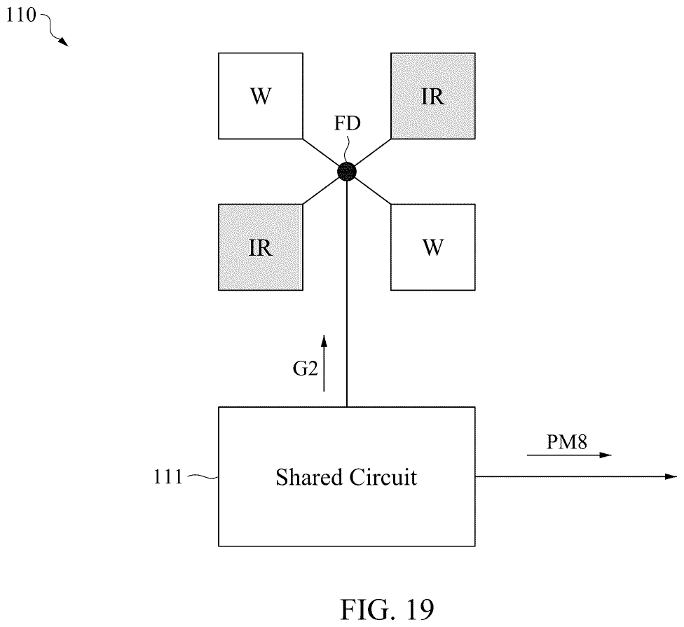

At Step 414, corresponding to FIG. 19, the floating diffusion node FD is set to the second conversion gain G2, and based on the second conversion gain G2, the electric charges stored in the two infrared pixels IR are converted into the eighth mixed pixel value PM8 during the fourth period. That is, the electric charges stored in the infrared pixels IR are simultaneously transferred to the floating diffusion node FD and are collectively converted into the eighth mixed pixel value PM8 based on the second conversion gain G2.

In the above embodiments of the disclosure, the first period precedes the second period, the second period precedes the third period, and the third period precedes the fourth period. That is, the pixel values in the first mode are read out in the following order: the first pixel value P1, the second pixel value P2, the third pixel value P3, and the fourth pixel value P4. The pixel values in the second mode are read out in the following order: the first mixed pixel value PM1, the second mixed pixel value PM2, the third mixed pixel value PM3, and the fourth mixed pixel value PM4. The pixel values in the third mode are read out in the following order: the fifth mixed pixel value PM5, the sixth mixed pixel value PM6, the seventh mixed pixel value PM7, and the eighth mixed pixel value PM8.

This disclosure incorporates dual conversion gain in the design of the W/IR sensor, enabling high gain and low gain switching for readout to simultaneously capture details in bright and dark regions, thereby enhancing the dynamic range (HDR) of the images. The disclosure further incorporates pixel binning technology to improve the SNR, data transmission rate and reducing the required readout capacity. In summary, the disclosure expands the application scenarios of W/IR sensors from basic imaging needs to various fields requiring high dynamic range, such as outdoor environments and surveillance systems.

Although the description provided above is of various embodiments of the disclosure, this should not limit the scope of the disclosure. Those with ordinary skill in the art can make various modifications without departing from the spirit and scope of the disclosure. Therefore, the scope of protection of the present disclosure shall be determined by the following claims.

What is claimed is:

1. An image sensor for capturing white light and infrared light, comprising:
a plurality of pixel groups, wherein each of the pixel groups comprising:
two white pixels and two infrared pixels sharing a floating diffusion node for selectively transferring a stored electric charge to the floating diffusion node; and
a shared circuit electrically connected to the floating diffusion node for selectively setting the floating diffusion node to a first conversion gain or a second conversion gain and converting the stored electric charge of each of the two white pixels and the two infrared pixels to a corresponding pixel value based on the first conversion gain or the second conversion gain;
wherein in response to the image sensor being operated in a first mode, one of the two white pixels is read as a first pixel value in a first period based on the first conversion gain, the other one of the two white pixels is read as a second pixel value in a second period based on the second conversion gain, one of the two infrared pixels is read as a third pixel value in a third period based on the first conversion gain, and the other one of the two infrared pixels is read as a fourth pixel value in a fourth period based on the second conversion gain.

2. The image sensor of claim 1, wherein each of the pixel groups comprises two rows and two columns, the one of the two white pixels is arranged in a first row and a first column, the one of the two infrared pixels is arranged in a second row and the first column, the other one of the two white pixels is arranged in the first row and a second column, and the other one of the two infrared pixels is arranged in the first row and the second column.

3. The image sensor of claim 1, further comprising:
a plurality of photoelectric conversion elements each corresponding to one of the two white pixels and the two infrared pixels; and
a plurality of transfer switches electrically connected between the floating diffusion node and a corresponding one of the photoelectric conversion elements and each of the transfer switches is configured to transfer the stored electric charge of the corresponding one of the photoelectric conversion elements to the floating diffusion node during an on-time period.

4. The image sensor of claim 3, wherein the shared circuit comprises a gain buffer and an output switch for determining timing and sequence in which the first pixel value, the second pixel value, the third pixel value and the fourth pixel value are readout in response to the on-time period of the plurality of transfer switches.

5. The image sensor of claim 4, wherein outputs of the gain buffers of at least two pixel groups are connected together.

6. The image sensor of claim 5, wherein in response to the image sensor being operated in a second mode, the gain buffers of the at least two pixel groups are simultaneously turned on to fuse the first pixel values of the at least two pixel groups into a first mixed pixel value in the first period, to fuse the second pixel values of the at least two pixel groups into a second mixed pixel value in the second period, to fuse the third pixel values of the at least two pixel groups into a third mixed pixel value in the third period, and to fuse the fourth pixel values of the at least two pixel groups into a fourth mixed pixel value in the fourth period.

7. The image sensor of claim 6, wherein in response to the image sensor being operated in a third mode, the two white pixels are readout as a fifth mixed pixel value in the first period based on the first conversion gain, and the two white pixels are readout as a sixth mixed pixel value in the second period based on the second conversion gain; and
the two infrared pixels are readout as a seventh mixed pixel value in the third period based on the first conversion gain, and the two infrared pixels are readout as an eighth mixed pixel value in the fourth period based on the second conversion gain.

8. The image sensor of claim 1, wherein the shared circuit comprises:
a capacitor; and
a first switch electrically connected between the capacitor and the floating diffusion node, wherein the capacitor is electrically connected to the floating diffusion node in response to turning on the first switch to set the floating diffusion node to the second conversion gain, and the capacitor is disconnected to the floating diffusion node in response to turning off the first switch to set the floating diffusion node to the first conversion gain.

9. The image sensor of claim 8, wherein the shared circuit comprises:
a second switch electrically connected between a supply voltage and the first switch for resetting the floating diffusion node.

10. The image sensor of claim 1, wherein the second conversion gain is smaller than the first conversion gain.

11. The image sensor of claim 1, wherein the first period precedes the second period, the second period precedes the third period, and the third period precedes the fourth period.

12. A method of acquiring pixel values for a pixel group of an image sensor, wherein the image sensor is used to capture white light and infrared light, and pixel group comprises two white pixels, two infrared pixels and a shared circuit, the two white pixels and the two infrared pixels share a floating diffusion node which is electrically connected to the shared circuit, the method comprising the following steps in response to the image sensor being operated in a first mode:
setting the floating diffusion node to a first conversion gain for converting a first electric charge stored in one of the two white pixels to a first pixel value in a first period based on the first conversion gain;
setting the floating diffusion node to a second conversion gain for converting a second electric charge stored in the other one of the two white pixels to a second pixel value in a second period based on the second conversion gain;
setting the floating diffusion node to the first conversion gain for converting a third electric charge stored in one of the two infrared pixels to a third pixel value in a third period based on the first conversion gain; and
setting the floating diffusion node to the second conversion gain for converting a fourth electric charge stored in the other one of the two infrared pixels to a fourth pixel value in a fourth period based on the second conversion gain.

13. The method of claim 12, further comprising the following steps in response to the image sensor being operated in a second mode:
fusing the first pixel values of at least two pixel groups into a first mixed pixel value in the first period;
fusing the second pixel values of the at least two pixel groups into a second mixed pixel value in the second period;
fusing the third pixel values of the at least two pixel groups into a third mixed pixel value in the third period; and
fusing the fourth pixel values of the at least two pixel groups into a fourth mixed pixel value in the fourth period.

14. The method of claim 13, further comprising the following steps in response to the image sensor being operated in a third mode:
setting the floating diffusion node to the first conversion gain for converting the first electric charge and the fourth electric charge stored in the two white pixels to a fifth mixed pixel value in the first period based on the first conversion gain;
setting the floating diffusion node to the second conversion gain for converting the first electric charge and the fourth electric charge stored in the two white pixels to a sixth mixed pixel value in the second period based on the second conversion gain;
setting the floating diffusion node to the first conversion gain for converting the second electric charge and the third electric charge stored in the two infrared pixels to a seventh mixed pixel value in the third period based on the first conversion gain; and
setting the floating diffusion node to the second conversion gain for converting the second electric charge and the third electric charge stored in the two infrared pixels to an eighth mixed pixel value in the fourth period based on the second conversion gain.

15. The method of claim 12, wherein the pixel group comprises two rows and two columns, the one of the two white pixels is arranged in a first row and a first column, the one of the two infrared pixels is arranged in a second row and the first column, the other one of the two white pixels is arranged in the first row and a second column, and the other one of the two infrared pixels is arranged in the first row and the second column.

16. The method of claim 12, wherein the second conversion gain is smaller than the first conversion gain.

17. The method of claim 12, wherein the first period precedes the second period, the second period precedes the third period, and the third period precedes the fourth period.

18. The method of claim 12, wherein the shared circuit comprises a capacitor and a first switch electrically connected between the capacitor and the floating diffusion node, the method further comprises:
turning off the first switch to disconnect the capacitor to the floating diffusion node for setting the floating diffusion node to the first conversion gain; and
turning on the first switch to connect the capacitor to the floating diffusion node for setting the floating diffusion node to the second conversion gain.

19. The method of claim 18, wherein the shared circuit further comprises a second switch electrically connected between a supply voltage and the first switch, the method further comprises:
resetting the floating diffusion node between each step of setting the floating diffusion node to the first conversion gain or the second conversion gain.
